(19) United States
(12) Patent Application Publication
(10) Pub. No.: US 2012/0291018 A1
(43) Pub. Date: Nov. 15, 2012

(54) METHOD AND APPARATUS FOR MANAGING EVALUATION OF COMPUTER PROGRAM CODE

(76) Inventor: Bhaskar Peri, Middlesex (GB)

(21) Appl. No.: 13/104,407

(22) Filed: May 10, 2011

(51) Int. Cl. G06F 9/44; G06F 17/30

(52) U.S. Cl. 717/126

(57) ABSTRACT

A computer implemented method of managing evaluation of computer program code is described, the method comprises receiving, in an input module, an input indicating a selection of computer program code for evaluation; receiving, in the input module, an input indicating a selection of rules, to be applied to the selection of computer program code from a plurality of rules, each rule of the plurality of rules indicating a criterion for compliance with the rule, the criterion for compliance being a result of at least one check on a portion of computer program code; and generating, in a processor, an indication for use in evaluating the computer program code indicating data comprising the selection of computer program code and the selection of rules.

### FIELD OF THE INVENTION

The present invention relates generally to managing the evaluation of computer program code by selecting rules for application to portions of computer program code.

### BACKGROUND OF THE INVENTION

Software development in a company may be spread over multiple projects with multiple developers working on each project. The projects may involve multiple phases of implementation. In order to ensure consistency of computer program code across and with-in the company, project or a logical grouping of work packages, developers and their managers may wish to evaluate the computer program code against standards. These may be industry standards such as ISO standards, business standards, companywide standards, project standards, regulatory or compliance standards or standards deemed relevant by the developer of the program or standards relevant or chosen for the specific phase of the life cycle of the software program or indeed standards that are specific to small portions of critical computer program code or standards that are a heterogeneous mixture of some or all of the above possible groupings but not limited to the above listing. The standards may check the maintainability, the suitability to deploy, the performance, and the readability of computer program code among other things. The required standard may vary for different phases of projects. Further, during the entire life cycle of a software program, new issues may arise which require the code involved in the project to be checked against new standards. Also, there is a need to keep the standards flexible so as to ignore some standards that are either not high priority or not applicable for certain scenarios.

Therefore in view of the above it is necessary to manage the evaluation of computer program code in a flexible way that allows standards to be shared and used and the application of standards to code to be effectively managed.

### SUMMARY OF THE INVENTION

According to an aspect of the present invention, there is provided a computer implemented method of managing evaluation of computer program code. An input indicating a selection of computer program code for evaluation is received in an input module. An input indicating a selection of rules to be applied to the selection of computer program code is received from the input module. The selection of rules is selected from a plurality of rules. Each rule of the plurality of rules indicates a criterion for compliance with the rule. The criterion for compliance is a result of at least one check to be carried out on a portion of computer program code. An indication for use in evaluating the computer program code indicating data comprising the selection of computer program code and the selection of rules is generated in a processor.

A rule may represent a standard or best practice in software programming.

Embodiments of the present invention provide for the selection of rules to be applied to specific portions of code.

According to an embodiment of the present invention, the code is evaluated by determining in the processor whether the selection of computer program code in the indication complies with the selection of rules. This evaluation is carried out by performing for each rule of the selection of rules the at least one check on the selection of computer program code. After performing the at least one check on the computer program code, the result is compared with the criteria for compliance.

According to an embodiment of the present invention, a report is generated in the processor indicating whether the selection of computer program code complies with the selection of rules. The report may be displayed or stored for retrieval in future. The report can provide information about the computer program code at various levels of aggregation for example by category, by number of non-conformances or any other relevant criteria or detail for example, by rule, by code, by project or by any other relevant criteria.

In an embodiment of the present invention, it is determined in the processor on the basis of the report whether to deploy the computer program code.

Embodiments of the present invention may also be used for general code review. This may be before the computer program code is ready for an immediate deployment. The report may be to check for compliance to regulatory standards or other standards or audits.

In an embodiment of the present invention, the at least one check on the computer program code is carried out in the processor and the result of the at least one check is compared with the criterion for compliance.

In an embodiment, an indication of at least one check on the selection of computer program code is displayed on a display. In response to this, a user may carry out the at least one check on the computer program code and input a result of the at least one check into the input module. Then, in the processor, the result of the at least one check is compared with the criterion for compliance.

In an embodiment of the present invention, each rule of the plurality of rules is associated with at least one type of computer program code. The method further comprises determining at least one type of computer program code included in the selection of computer program code. Then, a set of rules associated with the type of computer program code included in the selection is determined and this set of rules is displayed on a display. This means that the rules displayed to a user are those that are relevant for the selection of computer program code.

According to an embodiment of the present invention, the plurality of rules comprises at least one mandatory rule and this mandatory rule is included in the indication for use in evaluating the computer program code. The mandatory rule, for example, may be a project or company specific rule that code on a specific project or code developed for a particular company must comply with.

According to an embodiment of the present invention, the input indicating the selection of computer program code comprises an indication of a tag included in the computer program code. The tag may indicate for example code relating to a specific version or release of computer program code. This may be entered for example as comments in the computer program code.

The input indicating the selection of computer program code may directly indicate a portion of computer program code. Alternatively, the input may involve identifying the code to be evaluated based on tags or other identifiers embedded within the code or parameters that can be used to identify the code to be evaluated. The parameters could be dates or specific identifiers that relate to a specific computer program code or set of computer program code.

According to an aspect of the present invention, there is provided a method for managing evaluation of computer program code. The method comprises displaying on a display a list of computer program code items and a list of rules from a plurality of rules. Each rule of the plurality of rules indicates a criterion for compliance with the rule. The criterion for compliance is a result of at least one check on a portion of computer program code. The method further comprises receiving in an input module an input indicating a selection of rules from the list of rules and a selection of computer program code items from the list of computer program code items. Then, an indication for use in evaluating the computer program code is generated in a processor. The indication for use in evaluating the computer program code shows the code corresponding to the selection of computer program code items and the selection of rules.

In an embodiment, the computer program code is organised in a hierarchical data structure and a list of computer program code items is displayed as a tree view.

According to an embodiment, the list of computer program code items to be displayed is determined in accordance with a user profile. Different users may have different levels of authorisation. For example, a developer may be authorised to manage the evaluation of parts of code on which he or she is working. A manager of a project may be authorised to carryout evaluation of all parts of the code of the project being managed.

A similar authorization as above may be performed for the rules. For example, only authorized users can manage (create/edit/delete) the rules. However, all users can create their own selection of rules. A particular user's selection of rules may only be visible to that user and invisible to other users.

According to an embodiment of the present invention, the list of rules is determined in accordance with a user profile. Thus, different users may have access to different rules for evaluating computer program code.

According to an embodiment of the present invention, the list of computer program code items may be determined in accordance with a project definition. Thus, all the computer program code items relating to a specific project may be displayed. Further, the project definition may include a project phase. The list of rules may be determined in accordance with this project phase.

According to an embodiment of the present invention, the list of rules displayed on the display may be determined using the computer program code type of the computer program code items displayed on the display.

According to an aspect of the present invention, there is provided a system for evaluating computer program code. The system comprises storage for a plurality of rules. Each rule of the plurality of rules indicates a criterion for compliance to standards or best practices. The criterion for compliance is a result of at least one check on a portion of code. The system further comprises storage for a plurality of computer program code identifiers. Each computer program code identifiers identifies a location of a computer program code element in a code repository. The system further comprises a user interface operable to receive an input of a selection of code from the repository and an input of a selection of rules from the plurality of rules. The system further comprises a management module operable to generate an indication for use in evaluating the computer program code indicating data comprising the selection of computer program code and the selection of rules.

According to an embodiment of the present invention, there is provided a system for evaluating computer program code. The system comprises storage for a plurality of rules. Each rule of the plurality of rules indicates a criterion for compliance. The criterion for compliance is the result of at least one check performed on a portion of computer program code. The system further comprises storage for a plurality of code identifiers. Each code identifier identifies a location of a code element in a code repository. The system further comprises a display operable to display a list of code identifiers from the plurality of code identifiers and a list of rules from the plurality of rules. The system further comprises a user interface operable to receive an input indicating a selection of rules from the list of rules and a selection of code items from a list of code items. The system further comprises a management module operable to generate an indication for use in evaluating the computer program code. The indication for use in evaluating the computer program code comprises data indicating the selection of code items and the selection of rules.

According to an embodiment of the present invention, there is provided a tangible computer readable medium storing computer executable instructions which when executed on a computer causes the computer to manage evaluation of computer program code in accordance with methods described above.

According to an embodiment of the present invention, there is provided a tangible storage medium storing a data structure. The data structure indicates a first set of computer program code items and a first set of rules. The data structure indicates that the first set of rules are to be applied to the first set of computer program code items. Such a data structure allows the management of computer program code in accordance with the methods and systems discussed above.

According to an embodiment of the present invention, the data structure further indicates a second set of computer program code items and a second set of rules. The data structure further indicates that the second set of rules are to be applied to the second set of computer program code items. Such a data structure allows the management of evaluation of computer program code where different rules are applied to different portions of computer program code.

According to an embodiment of the present invention, the second set of computer program code items is a subset of first set of computer program code items and the data structure indicates that the first set of rules and the second set of rules are to be applied to the second set of computer program code items. Such a data structure would be used to control the evaluation of computer program code where additional rules were to be applied to a specific set of computer program code items.

According to an aspect of the present invention, there is provided an apparatus for managing evaluation of computer program code. The apparatus comprises means for receiving an input indicating a selection of computer program code for evaluation. The apparatus further comprises means for receiving an input indicating a selection of rules. The apparatus further comprises means for generating an indication for use in evaluating the computer program code indicating data comprising the selection of computer program code and the selection of rules.

According to an aspect of the present invention, there is provided an apparatus for managing evaluation of computer program code. The apparatus comprises means for displaying a list of computer program code items and a list of rules. The list of rules is from a plurality of rules, each rule of the plurality of rules indicates a criterion for compliance with the rule. The criterion for compliance is a result of at least one check on a portion of computer program code. The apparatus further comprises means for receiving an input indicating a selection of rules from the list of rules and a selection of computer program code items from the list of computer program code items. The apparatus further comprises means for generating an indication for use in evaluating the computer program code showing the code corresponding to the selection of computer program code items and the selection of rules.

According to an aspect of the present invention, there is provided a system for managing evaluation of the computer program code. The system comprises memory for storing a plurality of rules; each rule of the plurality of rules indicates a criterion for compliance. The criterion for compliance is the result of at least one check on a portion of code. The system further comprises memory for storing a plurality of computer program code identifiers; each computer program code identifier identifies a location of a computer program code element in a code repository. The system further comprises a processor operable to receive an input of a selection of computer program code from the repository and an input of a selection of rules from the plurality of rules. A processor is further operable to generate an indication for use in evaluating the computer program code indicating data comprising the selection of code and the selection of rules.

According to an aspect of the present invention, there is provided a system for managing evaluation of computer program code. The system comprises memory for storing a plurality of rules. Each rule of the plurality of rules indicates a criterion for compliance. The criterion for compliance is the result of at least one check performed on a portion of computer program code. The system further comprises memory for storing a plurality of code identifiers. Each code identifier identifies a location of computer program code element in a code repository. The system further comprises a processor. The processor is operable to generate a list of computer program code identifiers from the plurality of computer program code identifiers and a list of rules from the plurality of rules. The processor is further operable to receive an input indicating a selection of rules from the list of rules and a selection of code items from the list of computer program code items. The processor is further operable to generate an indication for use in evaluating the computer program code indicating data comprising the selection of computer program code and the selection of rules.

According to an aspect of the present invention, there is provided a system for evaluating computer program code. The system comprises a repository storing a plurality of computer program code items. The repository is coupled to a network. The system further comprises a data store coupled to the network. The data store stores a plurality of rules. Each rule of the plurality of rules indicates a criterion for compliance. The criterion for compliance is a result of at least one check on a portion of computer program code. The system further comprises an input module coupled to the network. The input module is operable to a receive a user input indicative of a selection of computer program code items from the plurality of computer program code items and a selection of rules from the plurality of rules. The system further comprises a management module implemented on a processor coupled to a network. The management module is operable to generate an indication for use in evaluating computer program code. The indication indicates data comprising a selection of computer program code and the selection of rules. The system further comprises an evaluation module implemented on a processor coupled to the network. The evaluation module is operable to determine whether the selection of computer program code in the indication complies with the selection of rules. This determination is made by performing for each rule in the selection of rules the at least one check on the selection of computer program code and comparing the result of the at least one check with the criterion for compliance.

### BRIEF DESCRIPTION OF THE DRAWINGS

In the following, embodiments of the present invention will be described as examples with reference to the drawings in which:

FIG. 1 is a block diagram of a system for managing evaluation of computer program code;

FIG. 2 is a flowchart illustrating a method of managing evaluation of computer program code;

FIG. 3 is a flowchart illustrating a method of managing evaluation of computer program code;

FIG. 4 is a screen shot of the items displayed during a method of managing the evaluation of computer program code;

FIG. 5 is a block diagram illustrating a data structure for use in a method of managing evaluation of computer program code;

FIG. 6 is a flowchart illustrating a method of evaluating computer program code;

FIG. 7 is a block diagram showing a system for managing evaluation of computer program code;

FIG. 8 shows a block diagram illustrating a system for managing evaluation of computer program code;

FIG. 9 shows a block diagram of a system for managing evaluation of computer program code;

FIG. 10 illustrates grouping rules from standards into rule lists;

FIG. 11 shows objects which may be associated with the Rule Lists described in relation to FIG. 10;

FIG. 12 shows an example of rules associated to categories;

FIG. 13 shows an example of rules associated with project phases; and

FIG. 14 illustrates how a parameter associated with a rule may be defined.

### DETAILED DESCRIPTION

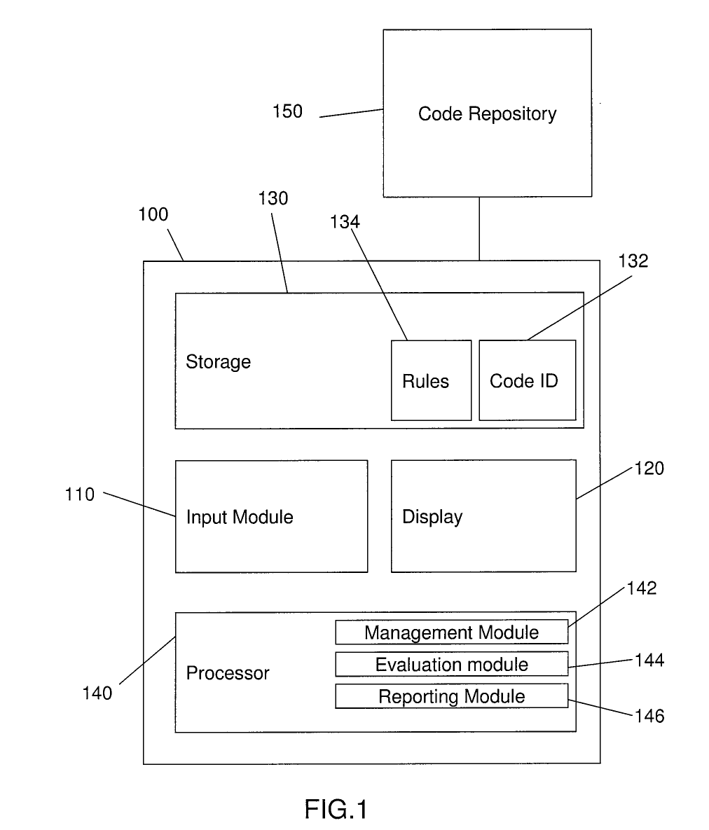

FIG. 1 illustrates a system 100 for managing evaluation of computer program code. The system comprises an input module 110, and display 120, storage 130, and a processor 140. The system is coupled to a code repository 150. The code repository 150 stores computer program code. The computer program code is text written in a computer programming language. Examples of computer program code are Informatica, Datastage, Business Objects Data Integrator, Business Objects, and Oracle Warehouse Builder. The input module 110 is operable to receive user inputs from an input device such as a keyboard or a mouse coupled to the system 100. The display 120 is operable to display user indications to a user of the system 100. The storage 130 stores code identifiers 132 and rules 134. The code identifiers identify portions of computer program code stored in a code repository 150 coupled to the system 100. The rules 134 are rules for evaluating portions of computer program code. The rules each comprise at least one check to be carried out on a portion of computer program code under evaluation. The result of the at least one check is then compared over a criterion for compliance with the rule.

The processor 140 implements a management mode 142, an evaluation module 144 and a reporting module 146. The methods implemented by the management module 142, the evaluation module 144 and the reporting module 146 will be described in a more detail below.

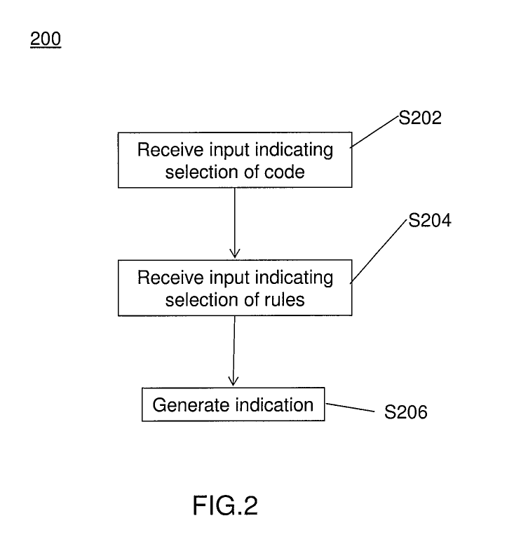

FIG. 2 is a flowchart 200 illustrating a method of managing evaluation of computer program code which may be implemented by management module 142 of the system 100 shown in FIG. 1. In S202, an indication of a selection of code is received in input module 110. The indication of the selection of code received in step S202 may include identifiers of a selection of code stored in the repository 150. Further, the code stored in the repository 150 may include labels or tags or dates indicating the creation or modification of a program or other parameters related to selection of the code. The labels or tags or dates or other indicators may indicate items of computer program code that are relevant to a particular version or release of a computer program or a group of computer programs that need evaluation against compliance rules. The input indicating a selection of code may indicate that computer program code having specific labels or tags is to be evaluated. In step S204, an indication of a selection of rules is received in the input module 110. Based on the inputs received in S202 and S204, the processor generates an indication for use in evaluating computer program code in step S206.

Each of the rules used in the evaluation of computer program code includes at least one check to be carried out on the code. The rules may be used to identify a particular pattern in the code which is known to cause a problem in the code. Thus, the rules identify pattern associated with potential problems in the code. The rules may include a threshold which is compared to a parameter of the computer program code. For example, a rule may specify a maximum number of steps that is permitted in a code module in a particular project. Such a rule would include a check which counted the number of steps when executed on a portion of code and a criterion for compliance with the rule which specified the threshold. The output of such a rule would be a binary indication of whether or not the rule was complied with by the code indicating whether the criterion for compliance with that particular rule had or had not been met.

Rules for evaluation of the computer program code fall into a number of possible categories. For example one such category is maintainability of computer program code. Rules falling into this category may include the length of expressions in the computer program code, a maximum number of steps that is allowed in the computer program code. Another possible category for rules is performance. Performance rules may specify particular techniques that are preferred in the code. For example SQL joins may be preferred to other possible data joins. A rule may include a check for the presence of the other types of joins. A further example of a performance rule is that unwanted data was filtered early.

Rules may be assigned to particular coding types or particular projects. Rules may also be assigned to particular phases of projects. For example certain rules may only be applicable in the deployment phase of a project. In such cases, methods of managing evaluation of computer program code may assist a user in selecting rules that are applicable to the selection of computer program code to be evaluated for suitability for deployment of the code. The evaluation may check for compliance to regulatory standards or other standards or audits.

Thus, embodiments of the present invention allow rules to be selected for a specific portion or portions of computer program code.

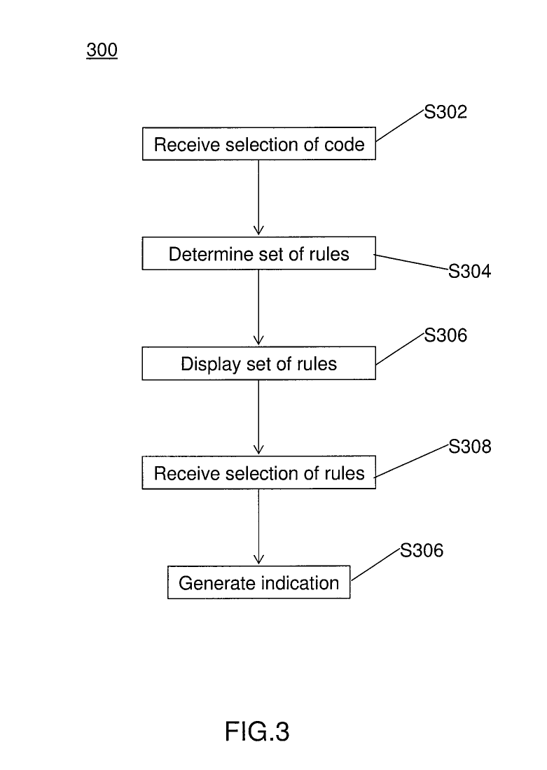

FIG. 3 shows a flowchart 300 illustrating a method of managing evaluation of computer program code. In step S302 an indication of a selection of computer program code for evaluation is received. In steps S304, a set of rules applicable to the selection of computer program code received in step S302 is determined. This determination may be made from the type of code selected in step S302 and using indications for the rules which indicate types of code to which the rules are applicable. Alternatively, the code selected in step S302 may be coupled to a particular project. The rules may be determined in step S302 according to the phase of the project. For example, particular rules may be applicable to projects in a deployment phase. In step S306, a set of rules determined in step S304 are displayed. In step S308, a selection of rules is received. In step S310, an indication indicating the selection of code and the selection of rules is generated.

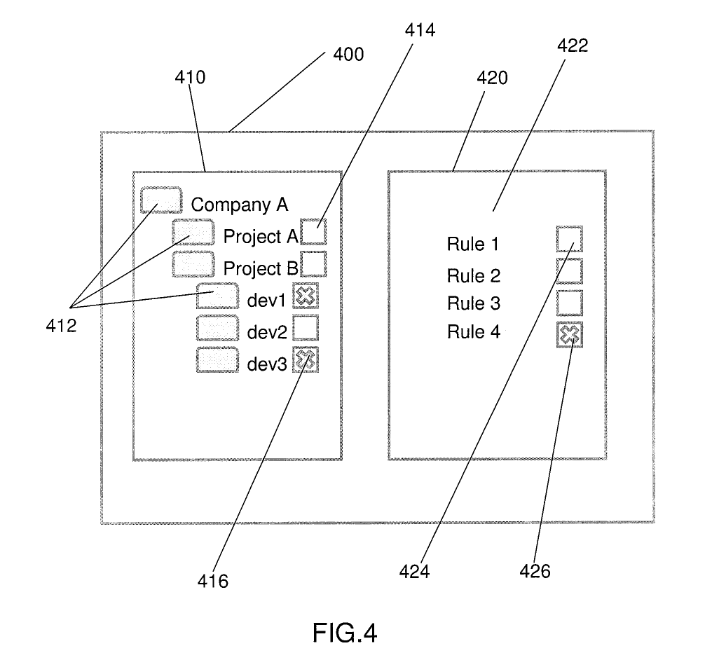

FIG. 4 shows a screen shot 400 illustrating a selection screen for a user to input selections of code items and rules in accordance with one of the methods discussed above. The screen 400 displays a list of code items 410 and a list of rules 420. The list of code items is displayed as a tree. The code items are grouped to projects which are grouped to a company. In the example shown in FIG. 4, code relating to project A and project B of company A is displayed. The code items are displayed as a hierarchy of folders 412. Each code item that can be selected has a box 414 next to it. A user can select either a complete project for evaluation or individual code items from a project for evaluation. In the example shown in FIG. 4, code items DEV 1 and DEV 3 are selected by putting a cross in the corresponding boxes 416.

The list of rules 420 is used to input a selection of rules to be applied to the selected code items. In the list 420 a number of rules 422 are displayed. Next to each rule is a selection box 424. In the example shown in FIG. 4, rule 4 is selected by putting a cross 426 in the corresponding box.

Alternatively, or additionally to displaying the list of rules 420, groupings of rules may be displayed. In this case the user selection indicates a grouping of rules.

Based on the user inputs illustrated above, a property file indicating the selection of code items and the selection of rules is generated. As discussed above in relation to FIG. 3, the list of rules 420 may be generated after the user has input the selection of code items. Alternatively, the list of rules and the list of code items may be generated together and displayed simultaneously. In this case, when the user makes a selection of code items, the corresponding rules in the list 420 may be highlighted, or any rules appearing in the list which are not applicable to the selection of code items may be greyed out.

The rules may be linked to one or more of the following: a project, a phase of a project, a company, a developer, and a category. The list of rules 420 may be generated following a user selection of a particular project, phase, company, developer or category from a menu. Alternatively, rules may be assigned to groups and the groups may be linked to one of the objects described above. In this case, the user may select groups of rules from the list, and alternatively or additionally, individual rules from the groups linked to the particular project, phase, company, developer or category selected from the menu

The selection of code items and the selection of rules may be made in different ways to that described above. For example, the rules may be selected for particular code items by dragging and dropping them onto the respective code items.

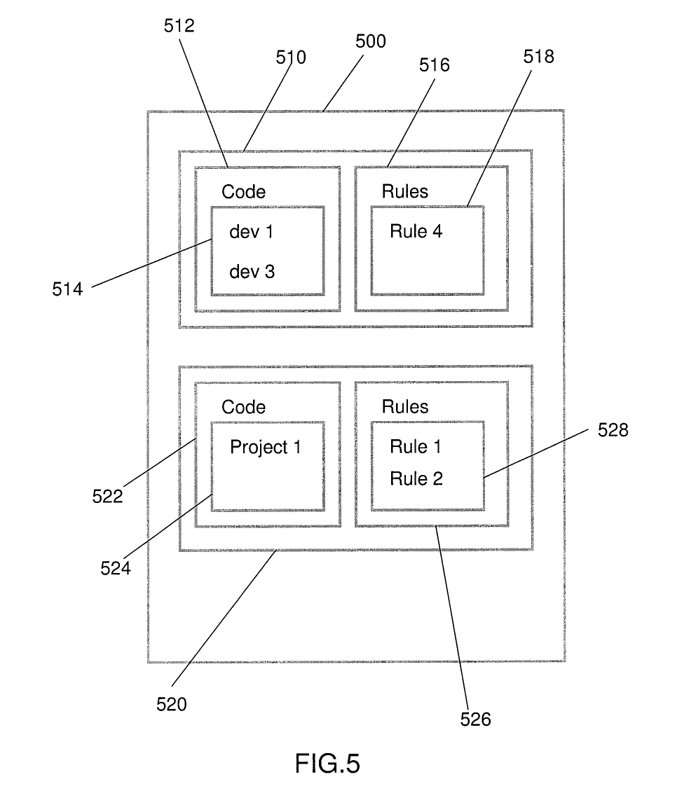

FIG. 5 shows a block diagram illustrating a data structure for evaluating computer program code. The data structure 500 indicates a first selection of code and a selection of rules 510 and a second selection of code and selection of rules 520. The first selection of code and selection of rules 510 includes a code section indicating a selection 514 of code items and a rules selection 516 indicating a selection of rules 518. The example shown here illustrates the selection shown in FIG. 4. In this selection of code items DEV 1 and DEV 3 are illustrated in the code selection 514 and rule 4 is indicated in the rule selection 518. The second selection of code items and rules 520 includes a code selection 522 which indicates project B as the selected code item 524 and the rules section 526 indicates rule 1 and rule 2 in a rule selection 528. In this example, rule 1 and rule 2 are applied to all the code assigned to project B. And rule 4 is applied to code items DEV 1 and DEV 3. With a structure, it is possible assign rules to a whole project and additionally additional rules to code items within the project.

Users with different roles may have authorisation to assign rules to different parts of the code hierarchy. For example, a project manager may be authorised to assign rules globally to a project while a developer may only be authorised to assign rules to code items within the parts of the project on which they are working. Thus, referring to the example shown in FIG. 5, a developer may be able to assign additional rules to be used in the evaluation of particular parts of the project but may not be able to change the rules assigned to the whole project. Thus, in the example shown in FIG. 5, rules 1 and 2 could have been assigned to project B by a project manager and rule 4 could have additionally been assigned to code items DEV 1 and DEV 3.

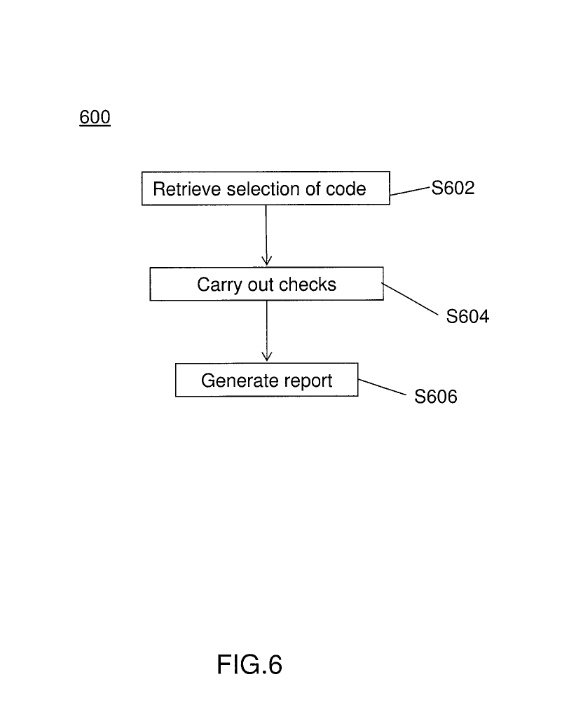

FIG. 6 shows a flowchart 600 illustrating the method involved in evaluating computer program code using for example the data structure 500 shown in FIG. 5. In step S602 the code selection indicated in the data structure is retrieved from the code repository. The code selection is retrieved by determining the location in the code repository of the code using the code identifiers stored in storage 310. In step 604, the evaluation module 144 carries out the checks on the code items listed in the rules 518 included in the list of rules 516. Additionally in step S604, the checks included in the rules 528 are carried out on the code listed in list 524. Then, in step 606, the reporting module 416 generates a report indicating the results of the checks carried out in step 604.

The checks forming the rules may be carried out by evaluation module 144. Or, alternatively, the checks themselves may be manually carried out by a user. In this case, the required checks would be displayed to a user and a user would manually carry out the check on the code. The manual execution of a check may include for example the user reviewing the code and inputting a result of the review. In response to this input, the evaluation module 144 compares the inputted result of the check with the criterion for compliance with the rule. Then, the reporting module 146 generates a report indicating the outcome of the check.

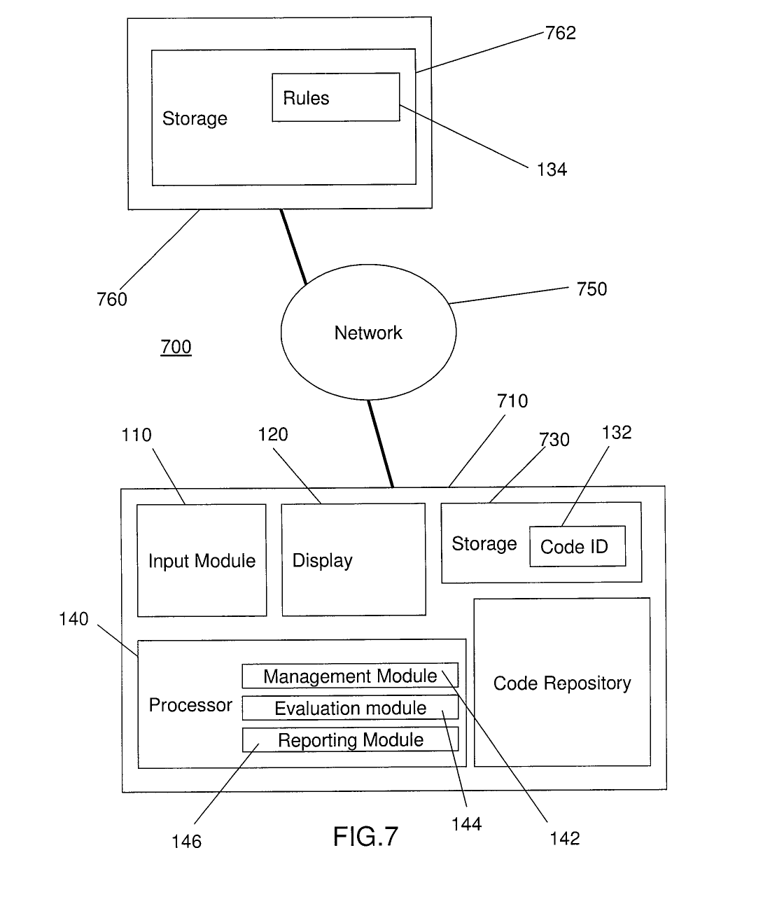

FIG. 7 shows a system 700 for managing evaluation of computer program code implemented over a network 750. The system 700 includes a system 710 on which the input module 110, the display 120, the processor 140 which implements the management module 142 the evaluation module 144 and the reporting module 146 are implemented. The system also includes storage 730 which stores code identifiers 132 and the system also includes code repository 150. The system 710 is connected via network 750 to a rule storage system 760. The rule storage system 760 includes storage 762 for rules 134. The system 700 implements the methods described above over the network 750. The system 700 allows rules stored remotely from the rest of the components of the system to be implemented and downloaded over network 750 for execution in the evaluation module 144 on processor 140.

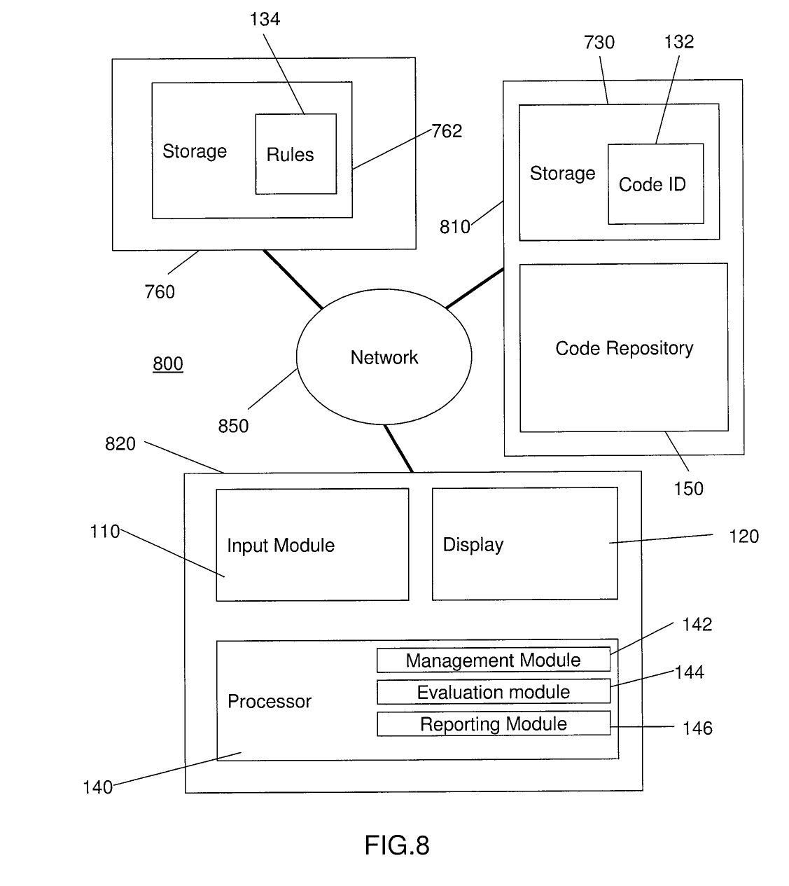

FIG. 8 shows a system 800 for implementing a method of managing evaluation of computer program code over a network 850. In the system shown in FIG. 8, the code repository 150 and the storage 730 of the code identifiers 132 are connected in system 810 which is coupled via network 850 to system 820 which implements the input module, the display and the processor. The processor implements the management module 142, the evaluation module 144 and the reporting module 146. The system 820 is connected via network 850 to a rule storage system 760 which implements storage 762 for rules 134.

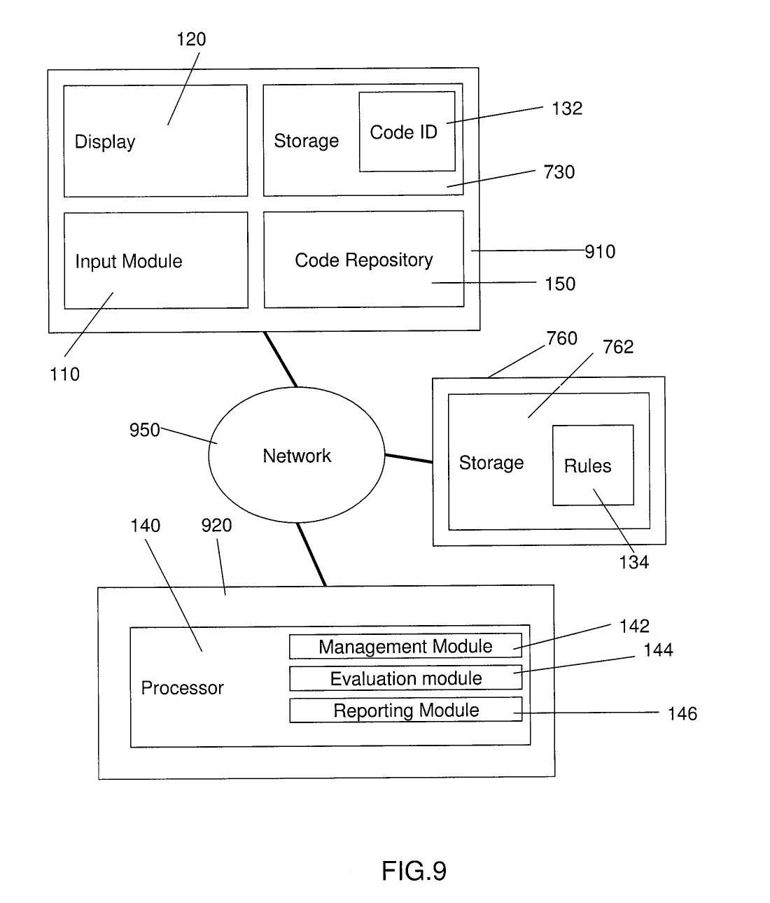

FIG. 9 shows a system 900 for managing evaluation of computer program code over a network 950. In the system 900, a client system 910 includes the input module 110, the display 120, the code repository 150, and the storage 730 for the code identifiers 132. The processor 140 implements on a web service system 920 which is accessible over network 950. The processor 140 implements the management module 142, the evaluation module 144 and the reporting module 146. The rules 134 are stored on storage 762 on rule storage system 760. Rule storage system 760 is coupled to the network 950. The system shown in FIG. 9 allows code stored in code repository 150 on the client system 910 to be evaluated using the program modules implemented as the web service 920.

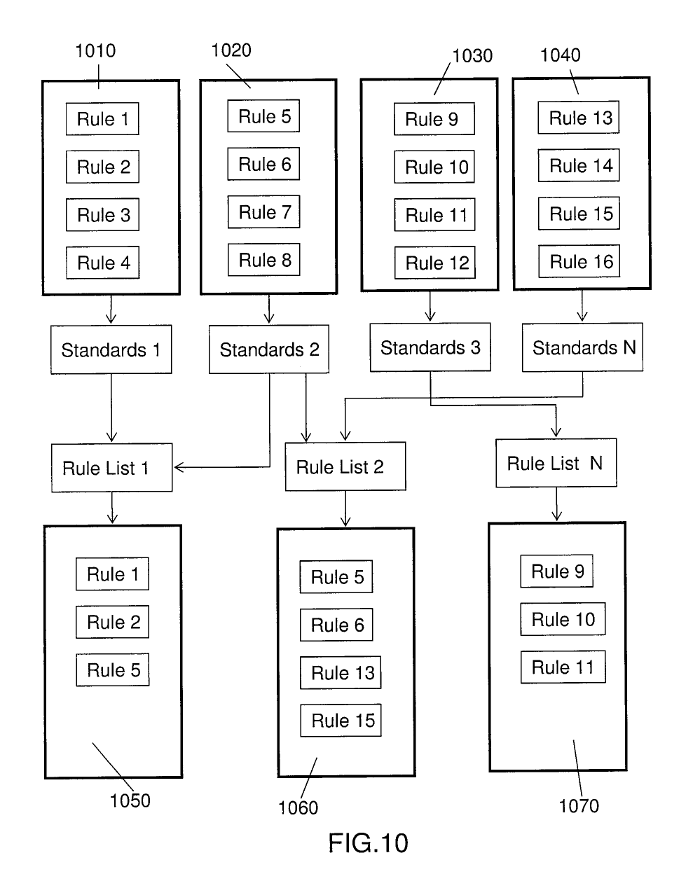

FIG. 10 illustrates how rules from different standards may be grouped into rule lists for use with embodiments of the present invention. A list of rules 1010, containing Rule 1, Rule 2, Rule 3, and Rule 4 is associated with Standard 1. A list of rules 1020 containing Rule 5, Rule 6, Rule 7 and Rule 8 is associated with Standard 2. A list of rules 1030 containing Rule 9, Rule 10, Rule 11 and Rule 12 is associated with Standard 3. A list of rules 1040 containing Rule 13, Rule 14, Rule 15 and Rule 16 is associated with Standard N. The rule lists 1010, 1020, 1030 & 1040 and the associated standards may be stored at different locations. The Standards 1, 2, 3 & N may be industry standards such as ISO standards, or may be based upon industry experience. Embodiments of the present invention allow rules from a different standards and locations to be applied in an efficient manner to a particular selection of computer program code.

To allow a user to manage evaluation of computer program code using embodiments of the present invention, rules from the standards are grouped together to form rule lists. Rules 1 and 2 from Standard 1 and Rule 5 from Standard 2 are included in Rule list 1 1050. Rules 5 and 6 from Standard 2 and Rules 13 and 15 from Standard N are included in Rule List 2 1060. Rules 9, 10 and 11 from Standard 3 are included in Rule List N 1070.

The Rule lists shown in FIG. 10 may be selected by a user using an interface similar to that shown in FIG. 4. As an alternative to, or in addition to being able to select individual rules for application to a selection of computer program code, a user may select any of the rule lists 1 to N shown in FIG. 10 for use in evaluating computer program code. A user may also be able to select one or more of the rule lists associated with Standards 1 to N for application to a selection of computer program code.

The standards may include General Standards, Regulatory Standards, Programme Standards, Company Standards, Project Standards, Phase Standards, User Standards, or a mixture of rules from all or some of the above.

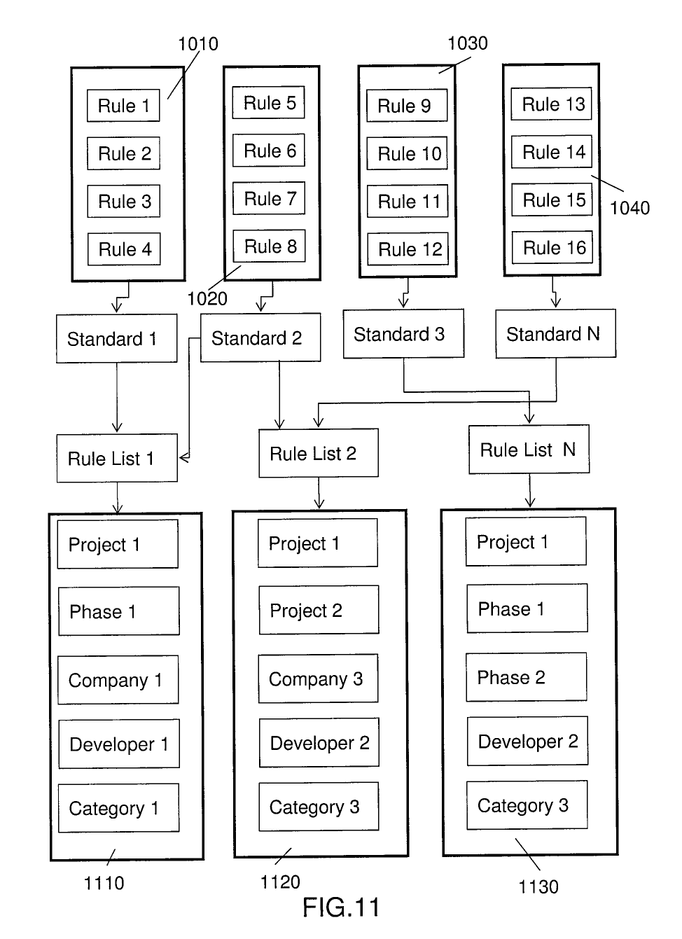

FIG. 11 shows attributes which may be associated with the Rule Lists described in relation to FIG. 10. As described in relation to FIG. 10, a list of rules 1010 is associated with Standard 1, a list of rules 1020 is associated with Standard 2, a list of rules 1030 is associated with Standard 3, and a list of rules 1040 is associated with Standard N. Rules selected from the lists of rules associated with the standards are included in Rule list 1, Rule list 2 and Rule list N.

As shown in FIG. 11, a set of objects 1110 is assigned to Rule list 1. Thus a Rule List can be made available or assigned to a Project or a Phase or a Company or to a developer. The set of objects indicates that Rule List 1 is assigned to Project 1. The set of objects 1110 also indicates that Rule List 1 is associated with Phase 1, Company 1, Developer 1 and Category 1. Phase 1 may indicate that the rules in the list are applicable to a particular phase of a project for example, deployment. Company 1 indicates that the rules in the list are applicable to Company 1. Developer 1 indicates that the rules in the list are applicable for or authorised for use by Developer 1. Category 1 indicates that the rules in the list are assigned to a particular category, for example maintainability of code.

Similarly, a set of objects 1120 is associated with Rule List 2. This set of objects 1120 indicates that Rule List 2 is applicable to Project 1 and Project 2, and associated with Company 3 and Developer 2, and is in Category 3. A further set of objects 1130 is associated with Rule list N. This set of objects 1130 indicates that Rule List N is associated with Project 1, Phase 1 and Phase 2, and Developer 2 and has Category 3.

The objects may be used in a variety of different ways to display the rules or rule lists to a user. For example, a user may select a portion of code belonging to a specific project for evaluation. The rule lists associated with this project may be displayed to the user for selection. Additionally, or alternatively, there may be a project phase associated with the project. In this case, the rule lists associated with this project phase may be displayed to the user for selection.

The user may be able to select rule lists by first selecting a project phase from a menu or list and the rule lists associated with that phase may then be displayed to the user. An analogous selection may be made for any of the other attributes.

The Developer attribute may be used to display Rule lists associated with the user or developer logged onto a workstation.

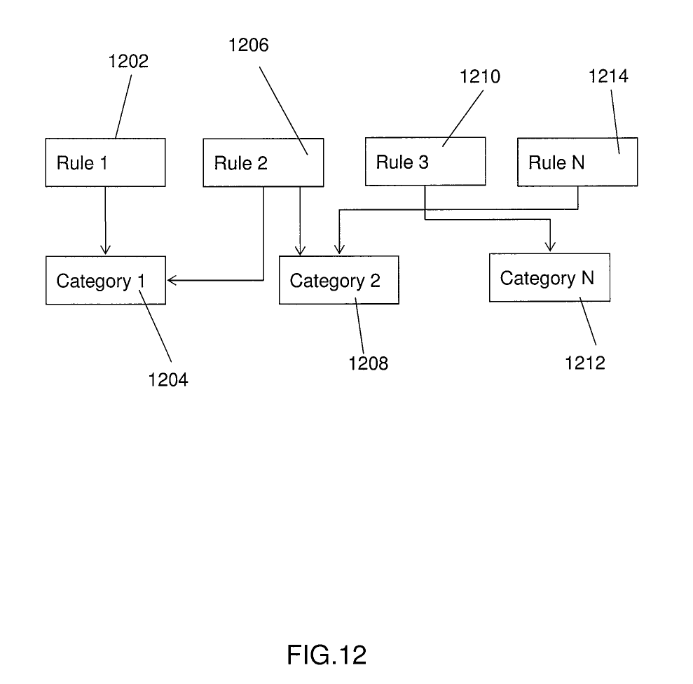

FIG. 12 shows an example of rules associated to categories. Rule 1 1202 is associated with Category 1 1204. Rule 2 1206 is associated with Category 1 1204 and Category 2 1208. Rule 3 1210 is associated with category N 1212. Rule N is associated with Category 2 1208. As shown in FIG. 12 a rule may be associated with more than one category. For example, a rule may be associated with both maintainability and performance.

Rules associated with a particular category may be selected by first selecting a category from a list. In response to this selection, a rules associated with that category are displayed. Then a user can select a rule or a list of rules associated with the category to evaluate a selection of code.

For example a rule that relates to the formatting of computer program code may affect two categories namely Readability and Maintainability. So a rule can belong to one or more category.

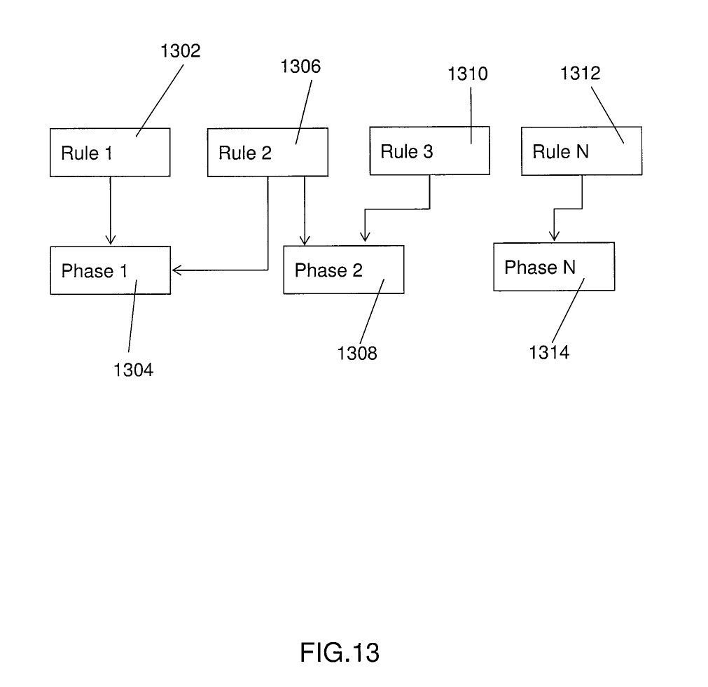

FIG. 13 shows an example of rules associated with project phases. Rule 1 1302 is associated with Phase 1 1304. Rule 2 1306 is associated with Phase 1 1304 and

Phase 2 1308. Rule 3 1310 is associated with Phase 2 1308. Rule N 1312 is associated with Phase N 1314. As shown in FIG. 13, a Rule may be associated with more than one phase. For example, a Rule may be associated with both implementation and deployment phases of a project cycle. Further, associated with a deployment phase there may be a list of rules that check the Performance aspects of the code as well as a list of rules that pertain to the Maintainability of the code. And indeed a Rule List called Deployment may comprise of all the rules pertaining to both Performance and Maintainability of the code.

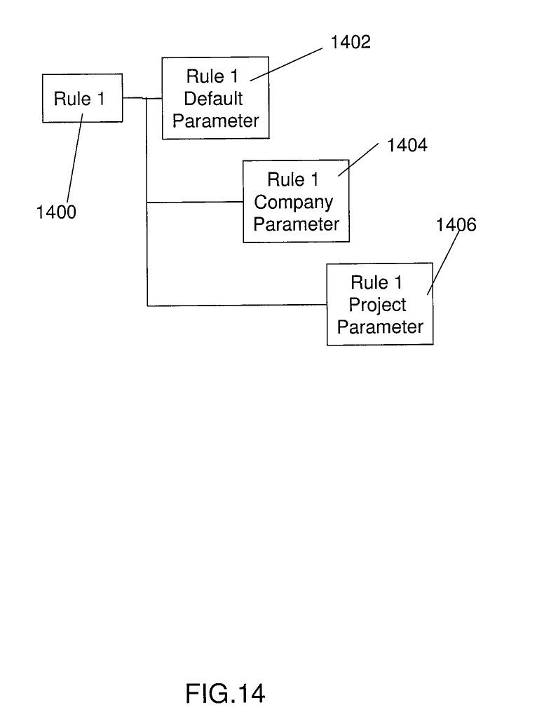

FIG. 14 illustrates how a parameter associated with a rule may be defined. Rule 1 1400 includes a check of the value of a parameter against a threshold. For example rule 1 1400 may specify a maximum number of lines of code. A default value 1402 is associated with Rule 1 1400. The value of the parameter may be defined as a Company specific parameter 1404, or a project specific parameter 1406. When the rule is used to evaluate computer program code, the relevant value is applied. The value of the parameter may or may not be displayed to a user when selecting the rule for evaluation of computer program code.

For example, rule 1 may be to ensure the code does not have more than a given number of lines of code. In this case there are various levels of overrides that can be implemented. The most general level could be the default which say indicates that the number of lines of code allowable for conformance is 2500 lines. If a company wants to enforce stricter standards across all the projects it has and says all projects should not have more than 1500 lines of code in a code. In this case an authorized user of the company will override the 2500 default by posting a 1500 override at a Company level. If subsequently a project want to expand or limit further they can override the value further by posting an override at the project level.

The evaluation of the computer program code selection using the rules may take place as a stage in the deployment of the computer program code. For example, the computer program code may be evaluated prior to deployment and the deployment may be conditional on the results reported by the reporting module.

The deployment of the code may be conditional on the report satisfying a set of rules. For example, these rules may check that there are no critical failures in the reporting result.

The report generated by the reporting module may allow a manager to enter notes or reasons why deployment of the code was allowed.

The report generated may be organised by rules or by computer program code elements. The rules may be ordered in order of importance. The reports may be stored as document files.

The evaluation of the code may be performed as a real-time check by a developer. A button or dashboard may be provided in the development interface. Once the evaluation is executed, a pre-selected set of rules are applied to the code under development. The selections of rules for application to the code are read from a data structure as described above in relation to FIG. 5.

Alternatively, a developer may be able to run a selection of rules by selecting a combination of rules and code items as discussed above.

The selection of code items could be based on a manual selection of code items or tags in the code or labels or dates indicating the creation or modification of a program or other parameters related to selection of the code, as particular code items.

While in the above description the management module, the evaluation module and the reporting module have all been shown as software implemented on a processor, it is contemplated that the modules may be implemented as either software or hardware or a combination of the two. Further, in the examples described above, the management module, the evaluation module and the reporting module are all shown implemented on the same processor, it is contemplated that they could be implemented on separate processors or indeed implemented on a parallel processor system. Further, the modules may be implemented on different sites in a distributed computing system.

The embodiments described above can be implemented by software on a general purpose computer or as a combination of software and hardware.

Embodiments of the invention may be implemented in the form of a computer readable medium carrying executable instructions which when executed on a computer cause the computer to carryout the methods described above. The computer readable medium may be a tangible computer readable medium storing computer code, for example an optical or magnetic storage medium or electronic solid state device such as a flash memory or a programmed hardware device. Alternatively, the computer readable medium may be a signal carrying computer program code such as an optical, electrical, or electromagnetic signal.

Although the present invention has been described with reference to embodiments, the present invention is not limited to these embodiments and modifications lie within the spirit and scope of the present invention.

1. A computer implemented method of managing evaluation of computer program code, the method comprising
receiving, in an input module, an input indicating a selection of computer program code for evaluation;
receiving, in the input module, an input indicating a selection of rules, to be applied to the selection of computer program code from a plurality of rules, each rule of the plurality of rules indicating a criterion for compliance with the rule, the criterion for compliance being a result of at least one check on a portion of computer program code; and
generating, in a processor, an indication for use in evaluating the computer program code indicating data comprising the selection of computer program code and the selection of rules.

2. The method of claim 1, further comprising
determining, in the processor, whether the selection of computer program code in the indication for use in evaluating the computer program code complies with the selection of rules, by performing, for each rule in the selection of rules, the at least one check on the selection of computer program code and comparing the result of the at least one check with the criterion for compliance.

3. The method of claim 2, further comprising
generating, in the processor a report indicating whether the selection of computer program code complies with the selection of rules.

4. The method of claim 3, further comprising determining, in the processor, on the basis of the report whether to deploy the computer program code.

5. The method of claim 2 wherein determining, in the processor, whether the selection of computer program code in the indication for use in evaluating the computer program code complies with the selection of rules comprises carrying out, in the processor, the at least one check on the selection of computer program code and comparing the result of the at least one check with the criterion for compliance.

6. The method of claim 1, wherein each rule of the plurality of rules is associated with at least one type of computer program code, the method further comprising,
determining, in the processor, at least one type of computer program code included in the selection of computer program code and determining from the plurality of rules a set of rules associated with at least one type of computer program code included in the selection of computer program code; and
displaying, on a display, an indication of the set of rules.

7. The method of claim 1, further comprising
displaying, on a display, an indication of at least one check on the selection of computer program code;
receiving an input, in the input module, of a result of the at least one check; and
comparing, in the processor, the result of the at least one check with the criterion for compliance.

8. The method of claim 1, wherein the plurality of rules comprises at least one mandatory rule and the indication for use in evaluating the computer program code indicates data comprising the selection of computer program code, the selection of rules, and the at least one mandatory rule.

9. The method of claim 1, wherein the input indicating a selection of computer program code for evaluation comprises an indication of a tag or label included in the computer program code, an indication of elements used to compile related elements of computer program code or an indication of at least one date or time of creation or modification

10. The method of claim 9, further comprising determining, in the processor, whether the selection of computer program code in the indication for use in evaluating the computer program code complies with the selection of rules, by performing, for each rule in the selection of rules, the at least one check on the computer program code having the tag or label and comparing the result of the at least one check with the criterion for compliance.

11. The method of claim 1, wherein the criterion for compliance defines a threshold which can be set to different values.

12. A computer implemented method of managing evaluation of computer program code, the method comprising
displaying, on a display, a list of computer program code items and a list of rules from a plurality of rules, each rule of the plurality of rules indicating a criterion for compliance with the rule, the criterion for compliance being a result of at least one check on a portion of computer program code,
receiving, in an input module, an input indicating a selection of rules from the list of rules and a selection of computer program code items from the list of computer program code items
generating, in a processor, an indication for use in evaluating the computer program code showing the computer program code corresponding to the selection of computer program code items and the selection of rules.

13. The method of claim 12, further comprising determining, in the processor, the list of computer program code items in accordance with a user profile.

14. The method of claim 12, further comprising determining, in the processor, the list of rules in accordance with a user profile, a project definition, a project phase or a category of rules.

15. The method of claim 12, further comprising determining, in the processor, the list of computer program code items in accordance with a project definition.

16. The method of claim 15, wherein the project definition includes a project phase, and each rule of the plurality of rules is associated with a project phase, the method further comprising determining, in the processor, the list of rules as the rules in the plurality of rules having an associated project phase matching the project phase of the project definition.

17. The method of claim 12 wherein each computer program code item in the list of computer program code items has a computer program code type and each rule of the plurality of rules is associated with a computer program code type and the method further comprises determining, in the processor, the list of rules as the rules from the plurality of rules that are associated with computer program code types of the computer program code items in the list of computer program code items.

18. A system for evaluating computer program code comprising
storage for a plurality of rules, each rule of the plurality indicating a criterion for compliance, the criterion for compliance being a result of at least one check on a portion of computer program code;
storage for a plurality of computer program code identifiers, each computer program code identifier identifying a location of a computer program code element in a code repository;
a user interface operable to receive an input of a selection of computer program code from the repository and an input of a selection of rules from the plurality of rules;
a management module operable to generate an indication for use in evaluating the computer program code indicating data comprising the selection of computer program code and the selection of rules.

19. A system for evaluating computer program code comprising
storage for a plurality of rules, each rule of the plurality indicating a criterion for compliance, the criterion for compliance being a result of at least one check on a portion of computer program code;
storage for a plurality of code identifiers, each code identifier identifying a location of a computer program code element in a code repository;
a display, operable to display a list of code identifiers from the plurality of code identifiers and a list of rules from the plurality of rules,
a user interface operable to receive an input indicating a selection of rules from the list of rules and a selection of computer program code items from the list of code identifiers; and
a management module operable to generate an indication for use in evaluating the computer program code indicating data comprising the selection of computer program code and the selection of rules.

20. A tangible computer readable medium storing computer executable instructions which when executed on a computer cause the computer to manage evaluation of computer program code, the instructions comprising
instructions for receiving, in an input module, an input indicating a selection of computer program code for evaluation;
instructions for receiving, in the input module an input indicating a selection of rules, to be applied to the selection of computer program code, from a plurality of rules, each rule of the plurality of rules indicating a criterion for compliance with the rule, the criterion for compliance being a result of at least one check on a portion of computer program code; and
instructions for generating, in a processor, an indication for use in evaluating the computer program code indicating data comprising the selection of computer program code and the selection of rules.

21. A tangible computer readable medium storing computer executable instructions which when executed on a computer cause the computer to manage evaluation of computer program code, the instructions comprising
instructions for displaying, on a display, a list of computer program code items and a list of rules from a plurality of rules, each rule of the plurality of rules indicating a criterion for compliance with the rule, the criterion for compliance being a result of at least one check on a portion of computer program code,
instructions for receiving, in an input module, an input indicating a selection of rules from the list of rules and a selection of computer program code items from the list of computer program code items
instructions for generating, in a processor, an indication for use in evaluating the computer program code showing the computer program code corresponding to the selection of computer program code items and the selection of rules.

22. A tangible storage medium storing a data structure indicating
a first set of computer program code items; and
a first set of rules from a plurality of rules from a plurality of rules, each rule of the plurality of rules indicating a criterion for compliance with the rule, the criterion for compliance being a result of at least one check on a portion of computer program code
the data structure further indicating that the first set of rules are to be applied to the first set of computer program code items.

23. The tangible storage medium storing a data structure of claim 22, the data structure further indicating
a second set of computer program code items; and
a second set of rules from a plurality of rules from a plurality of rules, each rule of the plurality of rules indicating a criterion for compliance with the rule, the criterion for compliance being a result of at least one check on a portion of computer program code
the data structure further indicating that the second set of rules are to be applied to the second set of computer program code items.

24. The tangible storage medium storing a data structure of claim 23, wherein the second set of computer program code items is a subset of the first set of computer program code items and the data structure indicates that the first set of rules and the second set of rules are to be applied to the second set of computer program code items.

25. An apparatus for managing evaluation of computer program code, the apparatus comprising
means for receiving an input indicating a selection of computer program code for evaluation;
means for receiving an input indicating a selection of rules, to be applied to the selection of computer program code from a plurality of rules, each rule of the plurality of rules indicating a criterion for compliance with the rule, the criterion for compliance being a result of at least one check on a portion of computer program code; and
means for generating an indication for use in evaluating the computer program code indicating data comprising the selection of computer program code and the selection of rules.

26. An apparatus for managing evaluation of computer program code, the apparatus comprising
means for displaying a list of computer program code items and a list of rules from a plurality of rules, each rule of the plurality of rules indicating a criterion for compliance with the rule, the criterion for compliance being a result of at least one check on a portion of computer program code,
means for receiving an input indicating a selection of rules from the list of rules and a selection of computer program code items from the list of computer program code items
means for generating an indication for use in evaluating the computer program code showing the computer program code corresponding to the selection of computer program code items and the selection of rules.

27. A system for managing evaluation of computer program code, the system comprising
memory for storing a plurality of rules, each rule of the plurality indicating a criterion for compliance, the criterion for compliance being a result of at least one check on a portion of computer program code;
memory for storing a plurality of computer program code identifiers, each computer program code identifier identifying a location of a computer program code element in a code repository;
a processor operable to receive an input of a selection of computer program code from the repository and an input of a selection of rules from the plurality of rules; and generate an indication for use in evaluating the computer program code indicating data comprising the selection of code and the selection of rules.

28. A system for managing evaluation of computer program code comprising
memory for storing a plurality of rules, each rule of the plurality indicating a criterion for compliance, the criterion for compliance being a result of at least one check on a portion of computer program code;
memory for storing a plurality of code identifiers, each code identifier identifying a location of a computer program code element in a code repository;
a processor operable to
generate a list of computer program code identifiers from the plurality of computer program code identifiers and a list of rules from the plurality of rules;
receive an input indicating a selection of rules from the list of rules and
a selection of computer program code items from the list of computer program code items; and
generate an indication for use in evaluating the computer program code indicating data comprising the selection of computer program code and the selection of rules.

29. A system for evaluating computer program code comprising
a repository storing a plurality of computer program code items coupled to a network;
a data store coupled to the network storing a plurality of rules, each rule of the plurality indicating a criterion for compliance, the criterion for compliance being a result of at least one check on a portion of computer program code;
an input module coupled to the network and operable to receive a user input indicative of a selection of computer program code items from the plurality of computer program code items and a selection of rules from the plurality of rules;
a management module implemented on a processor coupled to the network and operable to generate an indication for use in evaluating the computer program code indicating data comprising the selection of computer program code and the selection of rules; and
an evaluation module implemented on a processor coupled to the network and operable to determine whether the selection of computer program code in the indication for use in evaluating the computer program code complies with the selection of rules, by performing, for each rule in the selection of rules, the at least one check on the selection of computer program code and comparing the result of the at least one check with the criterion for compliance.
